(19) United States
(12) Patent Application Publication
(10) Pub. No.: US 2017/0129458 A1
(43) Pub. Date: May 11, 2017

(54) VEHICLE CONTROL METHOD AND DEVICE

(71) Applicant: Leauto Intelligent Technology (BEIJING) Co., Ltd., Beijing (CN)

(72) Inventor: Liting GE, Beijing (CN)

(21) Appl. No.: 14/968,560

(22) Filed: Dec. 14, 2015

(30) Foreign Application Priority Data
Nov. 5, 2015 (CN) 201510745191.9

(51) Int. Cl. B60R 25/30; B60R 25/10; B60R 25/104; B60R 1/00

(52) U.S. Cl. CPC B60R 25/305; B60R 1/00; B60R 25/1012; B60R 25/104; B60R 25/302; B60R 2300/8073; B60R 2025/1016

(57) ABSTRACT

The embodiments of the present disclosure provide vehicle control method and device, to overcome the problems that powerful evidences for dealing with the damaged vehicle cannot be obtained if the vehicle owner falls to hear alarm sound or cannot immediately return to the spot of vehicle in existing technology of parking security. The method includes: monitoring whether a warning apparatus of a vehicle is triggered to raise alarm after determining the vehicle is locked; and switching on a camera apparatus in the vehicle to capture multimedia data about surroundings of the vehicle when the warning apparatus is triggered to raise alarm. According to the embodiments of the disclosure, even if the vehicle owner falls to hear alarm sound or cannot immediately return to the spot of vehicle, powerful evidences for dealing with the damaged vehicle can be provided for the vehicle owner.

### CROSS-REFERENCE TO RELATED APPLICATIONS

This application claims priority to Chinese Patent Application No. CN201510745191.9, filed Nov. 5, 2015, the entire contents of all of which are incorporated herein by reference.

### TECHNICAL FIELD

The embodiments of the present disclosure relate to the field of vehicle electronic technologies, and particularly to vehicle control method and device.

### BACKGROUND

With rapid development of science and technology, automobile industry becomes flourishing. At present, vehicles have become relatively favored means of transportation. Vehicles are used not only as transportation tools for commuting and travelling but also as shuttle buses of companies and schools, providing great convenience for people.

As dependence of people on vehicles is being increased, vehicle safety becomes a relatively concerned problem. In the prior art, as to traffic safety for example, a driving recorder can be mounted in the vehicle, by which driving process can be recorded in order to provide reference basis for dangers encountered in the driving process. As to parking security for another example, a warning apparatus can be mounted in the vehicle, which could give alarm to the vehicle owner if the vehicle is subjected to damage of an external force after being locked.

In above manner of dealing with above parking security, the vehicle owner must return immediately to see damaged condition of the vehicle after hearing the alarm. If, however, the vehicle owner falls to hear alarm sound or cannot immediately return to the spot of vehicle, he/she could not know the related condition and thus could not obtain powerful evidences for dealing with the damaged vehicle.

### SUMMARY

The embodiments of the disclosure provide vehicle control method and device, to overcome the problems that powerful evidences for dealing with the damaged vehicle cannot be obtained if the vehicle owner falls to hear alarm sound or cannot immediately return to the spot of vehicle in existing technology of parking security.

The embodiment of the disclosure provides a vehicle control method, including:

monitoring whether a warning apparatus of a vehicle is triggered to raise alarm after determining the vehicle is locked; and

switching on a camera apparatus in the vehicle to capture multimedia data about surroundings of the vehicle when the warning apparatus is triggered to raise alarm.

The embodiment of the disclosure provides a vehicle control device, including:

a monitoring module, configured to monitor whether a warning apparatus of a vehicle is triggered to raise alarm after determining the vehicle is locked; and

a switching-on module, configured to switch on a camera apparatus in the vehicle to capture multimedia data about surroundings of the vehicle when the warning apparatus is triggered to raise alarm.

The embodiment of the present disclosure provides a vehicle control device, including:

a processor;

a memory for storing instructions executable by the processor,

wherein the processor is configured to:

monitor whether a warning apparatus of a vehicle is triggered to raise alarm after determining the vehicle is locked; and

switch on a camera apparatus in the vehicle to capture multimedia data about surroundings of the vehicle when the warning apparatus is triggered to raise alarm.

The vehicle control device according the embodiment of the disclosure could monitor whether the vehicle is triggered to raise alarm upon the determination of the locking of the vehicle in order to grasp whether the vehicle is damaged at this point; when the warning apparatus is triggered to raise alarm, the camera apparatus in the vehicle can be switched on to capture multimedia data about surroundings of the vehicle, such that current damage condition of the vehicle could be recorded. Therefore, even if the vehicle owner falls to hear alarm sound or cannot immediately return to the spot of vehicle, powerful evidences for dealing with the damaged vehicle can be provided for the vehicle owner.

### BRIEF DESCRIPTION OF THE DRAWINGS

In order to more apparently describe the technical schemes in the embodiments of the disclosure or in the prior art, accompanying figures necessarily used in the description of the embodiments or the prior art will be simply explained hereinafter. Obviously, the accompanying figures described below will form the embodiments of the disclosure. An ordinary person skilled in the art may conceive further figures in accordance with these accompanying figures without contributing creative labor.

FIG. 1 is a flow chart showing a vehicle control method according to a first embodiment of the disclosure;

FIG. 2 is a flow chart showing a vehicle control method according to a second embodiment of the disclosure;

FIG. 3 is a block diagram showing a vehicle control device according to a third embodiment of the disclosure; and

FIG. 4 is a block diagram showing a vehicle control device according to a fourth embodiment of the disclosure.

FIG. 5 is a block diagram schematically showing the vehicle control device for executing the methods according to the present disclosure.

FIG. 6 is a schematic diagram showing a memory for saving or carrying instructions according to the present disclosure.

### DETAILED DESCRIPTION

In order that objectives, technical schemes and advantages of the embodiments of the disclosure become more apparent, the technical schemes in the embodiments of the disclosure will be thoroughly and completely described below in conjunction with the accompanying figures in the embodiments of the disclosure. It is obvious that the embodiments described herein are some of embodiments of the disclosure rather than entire embodiments. On the basis of the embodiments of the disclosure, other embodiments conceived by an ordinary person skilled in the art without creative labor would all fall into the scope of the present disclosure.

### First Embodiment

With reference to FIG. 1, it shows a flow chart of a vehicle control method according to a first embodiment of the disclosure.

The vehicle control method according to this embodiment of the disclosure may include steps of:

Step 101, monitoring whether a warning apparatus of a vehicle is triggered to raise alarm after determining the vehicle is locked.

In this embodiment of the disclosure, “the vehicle is locked” means a case that the vehicle is actively locked after the vehicle is parked and the vehicle owner leaves the vehicle. As to the problem that only the warning apparatus is in charge of the parking security after the vehicle owner leaves with the vehicle locked, the embodiment of the disclosure can be in connection with an inherent warning apparatus of the vehicle and in association with the warning apparatus of the vehicle (for example, in association with the warning apparatus via CAN (Controller Area Network) bus). Upon the determination of the locking of the vehicle, whether the warning apparatus is triggered to raise alarm could be monitored such that whether the vehicle is damaged at this point can be grasped and thus what action is necessarily to take can be determined.

Herein, “monitoring” could be monitoring in real time or monitoring in accordance with a preset time interval. For the time interval, any suitable value (for example, 3s or 5s) may be set by those skilled in the art according to their experience. The specific numerical value is not restricted by the embodiment of the disclosure.

Step 102, switching on a camera apparatus in the vehicle to capture multimedia data about surroundings of the vehicle when the warning apparatus is triggered to raise alarm.

The embodiment of the disclosure can be in connection with a camera apparatus mounted in the vehicle and in association with the camera apparatus in the vehicle (for example, in association with the camera apparatus via the CAN bus). In the case of detecting the warning apparatus is triggered to raise alarm, it proves the vehicle is being damaged. At this time, the camera apparatus in the vehicle can be switched on such that the multimedia data about the surroundings of the vehicle can be captured through the camera apparatus. The multimedia data can describe the surroundings of the vehicle. Therefore, current damage condition of the vehicle could be obtained according to the multimedia data. If the warning apparatus is not triggered, it may prove the vehicle is secure now. At this time, it is unnecessary to switch on the camera apparatus, and the process will return to and repeat the step of monitoring whether the warning apparatus of the vehicle is triggered to raise alarm.

Herein, the camera apparatus can be a camera in a full-view parking system included in the vehicle, or a full-view camera individually arranged at a specified position of the vehicle. Any suitable position can be selected for the specified position by those skilled in the art according to their experience, as long as the full-view camera arranged at the specified position is able to clearly capture the multimedia data about the surroundings of the vehicle. For example, the vehicle roof can be set as the specified position, which is not restricted by the embodiment of the disclosure.

The vehicle control method according the embodiment of the disclosure could monitor whether the vehicle is triggered to raise alarm upon the determination of the locking of the vehicle in order to grasp whether the vehicle is damaged at this point can be grasped; when the vehicle is triggered to raise alarm, the camera apparatus in the vehicle can be switched on to capture multimedia data about surroundings of the vehicle, such that current damage condition of the vehicle could be recorded. Therefore, even if the vehicle owner falls to hear alarm sound or cannot immediately return to the spot of vehicle, powerful evidences for dealing with the damaged vehicle can be provided for the vehicle owner.

### Second Embodiment

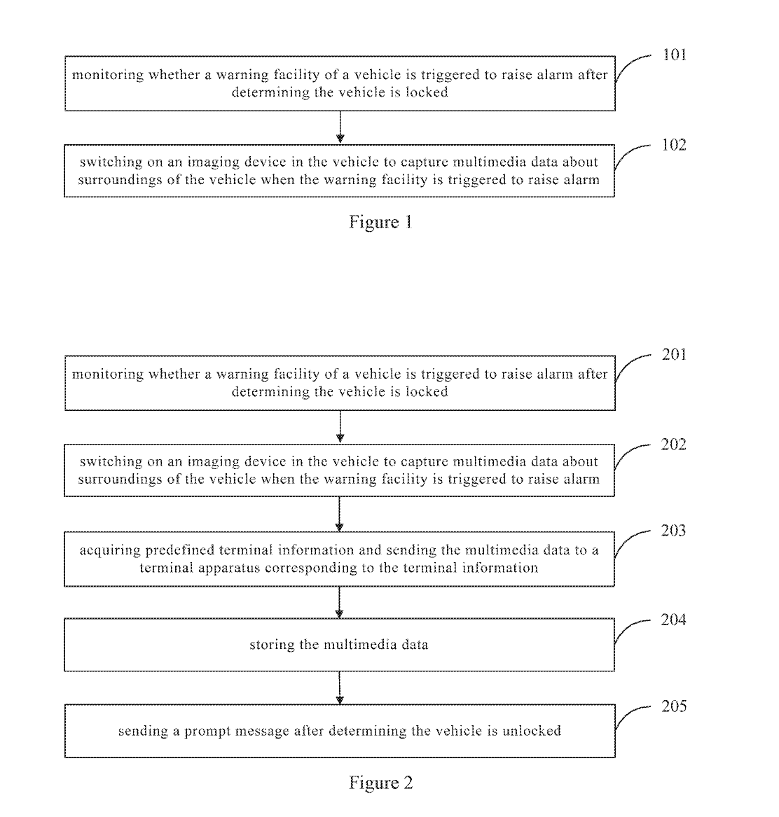

With reference to FIG. 2, it shows a flow chart of a vehicle control method according to a second embodiment of the disclosure.

The vehicle control method according to the embodiment of the disclosure may include steps of:

Step 201, monitoring whether a warning apparatus of a vehicle is triggered to raise alarm after determining the vehicle is locked.

In this embodiment of the disclosure, when the vehicle is parked and the vehicle owner leaves with actively locking the vehicle, he/she may send a lock signal to the vehicle. For example, the vehicle's key can send a lock signal when its lock button is pressed by the vehicle owner, and thus the locking of the vehicle can be determined upon the receipt of the lock signal.

When the locked vehicle is subjected to damages by external forces (for example, impact by another vehicle or malicious damage by a person), the warning apparatus of the vehicle will raise alarm information (for example, the warning apparatus will raise sound alarm information) after detecting the damage event. When detecting the alarm information from the warning apparatus, the embodiment of the disclosure can determine the warning apparatus is triggered to raise alarm and in turn to determine alarm event occurs in the warning apparatus. Therefore, the process of monitoring whether the warning apparatus of the vehicle is triggered to raise alarm may include: monitoring whether the warning apparatus transmits alarm information, wherein if the warning apparatus transmits alarm information, it is determined the warning apparatus is triggered to raise alarm.

Step 202, switching on a camera apparatus in the vehicle to capture multimedia data about surroundings of the vehicle when the warning apparatus is triggered to raise alarm.

In the case of detecting the warning apparatus is triggered to raise alarm, it proves the vehicle is being damaged. At this time, the camera apparatus in the vehicle can be switched on. In the embodiment of the disclosure, the process of switching on the camera apparatus may include: sending a switching-on instruction to the camera apparatus of the vehicle such that the camera apparatus is automatically switched on after the receipt of the switching-on instruction. The camera apparatus could start to capture the multimedia data about surroundings of the vehicle after being switched on. The process of capturing the multimedia data may include: taking photos and/or recording videos on the surroundings of the vehicle, wherein the photos and/or videos are multimedia data. In the embodiment of the disclosure, the meaning “and/or” is to include at least one of them, that is to say, it is possible to merely take photos on the surroundings of the vehicle, merely record videos on the surroundings of the vehicle, and also both take photos and record videos on the surroundings of the vehicle.

Preferably, in order to save electric energy and reduce power consumption, operating time of the camera apparatus can be defined in the embodiment of the disclosure. Accordingly, after switching on the camera apparatus of the vehicle, the method may further include a step of determining whether a defined time is reached and switching off the camera apparatus when determining the defined time is reached. The process of switching off the camera apparatus in the embodiment of the disclosure may include: sending a switching-off instruction to the camera apparatus of the vehicle such that the camera apparatus is automatically switched off after the receipt of the switching-off instruction. The camera apparatus could stop capturing the multimedia data about surroundings of the vehicle after being switched off. For the defined time, any suitable value (for example, 2 min or 4 min) may be set by those skilled in the art according to their experience. The specific numerical value is not restricted by the embodiment of the disclosure.

It should be explained, within the defined time, if the camera apparatus records videos on the surroundings of the vehicle, a time length of video may be equal to the defined time; if the camera apparatus takes photos on the surroundings of the vehicle, photos may be taken according to a defined frequency. For example, one photo is taken every 1s or 5s.

Step 203, acquiring predefined terminal information and sending the multimedia data to a terminal apparatus corresponding to the terminal information.

In the embodiment of the disclosure, a Modem (modulator-demodulator) module can be mounted in the vehicle to complete mutual communication between the vehicle and the terminal apparatus (for example, a mobile phone of the vehicle owner). Terminal information can be set in advance and stored in the vehicle, wherein the terminal information, such as mobile phone number, is unique information to find the terminal apparatus. When there is a need to communicate with the terminal apparatus, it is possible to acquire the set terminal information, based on which the corresponding terminal apparatus can be found and the captured multimedia data can be sent to the corresponding terminal apparatus. For example, the multimedia data can be sent to the corresponding terminal apparatus by MMS (multimedia message).

It should be explained, in the embodiment of the disclosure, said terminal information may be information of one terminal apparatus, or information of at least two terminal apparatuses. That is to say, in the embodiment of the disclosure, the multimedia data may be sent to one terminal apparatus or may be sent to at least two terminal apparatuses, which is not restricted herein.

Step 204, storing the multimedia data.

In the embodiment of the disclosure, the multimedia data about surroundings of the vehicle captured by the camera apparatus at Step 202 can be stored to provide the vehicle owner with these multimedia data for reviewing after he/she returns to the vehicle. The multimedia data may be stored to a storage device in the vehicle. The storage device may be a storage device included in the vehicle, or a storage device separately provided in the vehicle and specially used for storing the multimedia data, such as USB flash disk.

Step 205, sending a prompt message after determining the vehicle is unlocked.

Since the multimedia data are stored at Step 204, the vehicle owner can review these stored multimedia data after he/she returns to the vehicle. In the embodiment of the disclosure, taking into account that the vehicle owner possibly may ignore to review due to being unaware that the vehicle is damaged in his/her absence or forget to review despite being aware that the vehicle is damaged in his/her absence, Step 205 is provided as a preferred fashion. That is, the prompt message may be sent after the determination of the unlocking of the vehicle, wherein the prompt message is used for reminding the vehicle owner to timely review the stored multimedia data. In the embodiment of the disclosure, a sound prompt message (for example, bleeps or voice “you have new multimedia data, please check”) can be made, or a text prompt message (for example, text “you have new multimedia data, please check”) can be displayed on a displaying device (for example, a screen of navigation system) included in the vehicle.

Herein, when the vehicle owner returns to the vehicle, he/she may send an unlock signal to the vehicle. For example, the vehicle's key can send an unlock signal when its lock button is pressed by the vehicle owner, and thus the unlocking of the vehicle can be determined upon the receipt of the unlock signal.

In the end, it should be explained, the method according to the embodiments of the disclosure may include all the Steps 201-205, or merely Steps 201-203, or merely Steps 201-202 and Step 204, or merely Steps 201-202 and Steps 204-205, which is not restricted herein.

According to the embodiments of the disclosure, it is possible to switch on the camera apparatus to capture correlative multimedia data when the vehicle is triggered to raise alarm, also to store the multimedia data for reviewing after the vehicle owner returns to the vehicle, also to remind the vehicle owner to timely review after he/she returns to the vehicle and also to timely send the captured multimedia data to the vehicle owner, in order to provide powerful evidences for dealing with the damaged vehicle and great convenience for the vehicle owner.

In the method embodiments as described above, for the purpose of brief description, they are described as a series of combined actions. However, it should be appreciated by those skilled in the art that the embodiments of the disclosure should not be restricted by the sequence of the actions as set forth, since some of actions could be performed in different sequence or simultaneously. Moreover, it should also be appreciated by those skilled in the art that, the embodiments as described in the specification are preferred embodiments and actions and modules concerned are not necessarily required in the disclosure.

### Third Embodiment

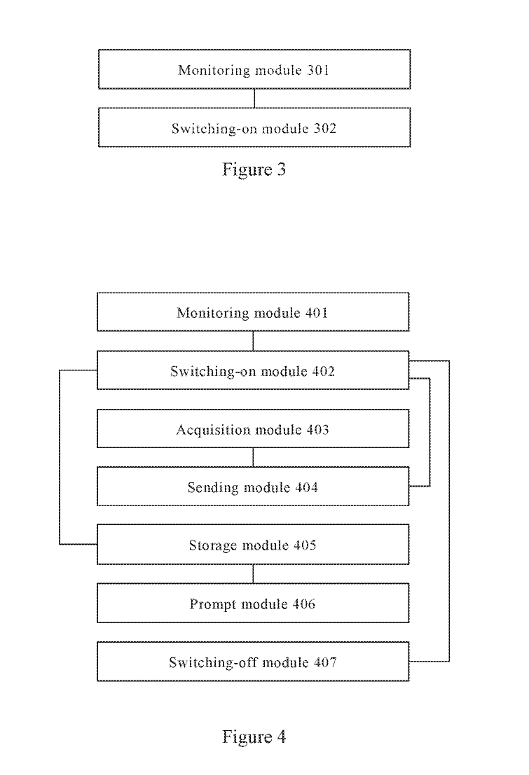

With reference to FIG. 3, it shows a block diagram showing a vehicle control device according to a third embodiment of the disclosure.

The vehicle control device according to this embodiment of the disclosure may include following modules:

a monitoring module 301, configured to monitor whether a warning apparatus of a vehicle is triggered to raise alarm after determining the vehicle is locked; and

a switching-on module 302, configured to switch on a camera apparatus in the vehicle to capture multimedia data about surroundings of the vehicle when the warning apparatus is triggered to raise alarm.

The vehicle control device according the embodiment of the disclosure could monitor whether the vehicle is triggered to raise alarm upon the determination of the locking of the vehicle in order to grasp whether the vehicle is damaged at this point; when the vehicle is triggered to raise alarm, the camera apparatus in the vehicle can be switched on to capture multimedia data about surroundings of the vehicle, such that current damage condition of the vehicle could be recorded. Therefore, even if the vehicle owner falls to hear alarm sound or cannot immediately return to the spot of vehicle, powerful evidences for dealing with the damaged vehicle can be provided for the vehicle owner.

### Fourth Embodiment

With reference to FIG. 4, it shows a block diagram showing a vehicle control device according to a fourth embodiment of the disclosure.

The vehicle control device according to this embodiment of the disclosure may include following modules:

a monitoring module 401, configured to monitor whether a warning apparatus of a vehicle is triggered to raise alarm after determining the vehicle is locked; and

a switching-on module 402, configured to switch on a camera apparatus in the vehicle to capture multimedia data about surroundings of the vehicle when the warning apparatus is triggered to raise alarm.

Preferably, the switching-on module 402 may be particularly configured to switch on the camera apparatus of the vehicle to take photos and/or record videos on the surroundings of the vehicle, wherein the photos and/or videos are multimedia data.

Preferably, the vehicle control device may further include: an acquisition module 403, configured to acquire predefined terminal information; and a sending module 404, configured to send the multimedia data to a terminal apparatus corresponding to the terminal information.

Preferably, the vehicle control device may further include: a storage module 405, configured to store the multimedia data.

Preferably, the vehicle control device may further include: a prompt module 406, configured to send a prompt message after determining the vehicle is unlocked, wherein the prompt message is used for reminding the vehicle owner to timely review the stored multimedia data.

Preferably, the vehicle control device may further include: a switching-off module 407, configured to determine whether a defined time is reached after the switching-on module switches on the camera apparatus of the vehicle, and switch off the camera apparatus when determining the defined time is reached.

According to the embodiments of the disclosure, it is possible to switch on the camera apparatus to capture correlative multimedia data when the vehicle is triggered to raise alarm, also to store the multimedia data for reviewing after the vehicle owner returns to the vehicle, also to remind the vehicle owner to timely review after he/she returns to the vehicle and also to timely send the captured multimedia data to the vehicle owner, in order to provide powerful evidences for dealing with the damaged vehicle and great convenience for the vehicle owner.

Since the device embodiments are substantially similar to the method embodiments as described, the description thereof is relatively simple. For the device embodiments, reference can be made to related parts of the method embodiments.

Each member embodiment of the present disclosure can be realized by hardware, or realized by software modules running on one or more processors, or realized by the combination thereof. A person skilled in the art should understand that a microprocessor or a digital signal processor (DSP) may be used in practical use to realize some or all the functions of some or all the members of the apparatus for recognizing advertisement plug-ins according to the embodiments of the present disclosure. The present disclosure may be further realized as some or all the equipments or device programs for executing the methods described herein (for example, computer programs and computer program products). This program for realizing the present disclosure may be stored in computer readable medium, or have one or more signal forms. These signals may be downloaded from the Internet website, or be provided by carrying signals, or be provided in any other manners.

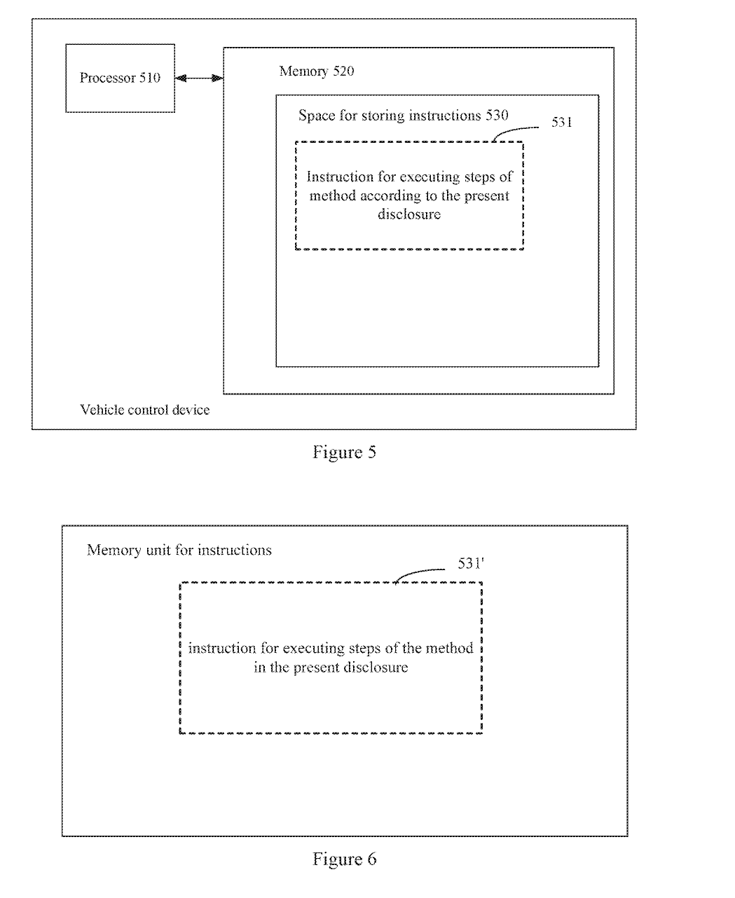

For example, FIG. 5 is a block diagram schematically showing a vehicle control device for executing the methods of the invention. The vehicle control device includes a processor 510 and a computer program product or computer readable medium in the form of memory 520. The memory 520 may be an electronic memory such as a flash memory, EEPRPOM (electrically erasable programmable read-only memory), EPROM (electrically programmable read-only memory), hard disk or ROM (read-only memory). The memory 520 has a memory space 530 for storing instructions for executing any of the steps in the above method. For example, the memory space 530 for storing the instructions may include each instruction 531 for realizing steps in the above methods respectively. The instruction may be read out from one or more computer program product or write in one or more computer program product. The computer program product includes instruction carrier such as hard disk, compact disk (CD), storage card, or soft disk. The computer program product is usually a portable or non-portable memory unit shown in FIG. 6. The memory unit may have similar-arranged memory paragraph, memory space and the like as the memory 520 of the vehicle control device in FIG. 5. The instructions may be, for example, compacted in appropriate form. Generally, the memory unit includes a computer readable code 531′, that is, the code which may be read by processor such as the processor 510. When the instruction is executed by the vehicle control device, the vehicle control device is made to execute the steps in the methods above.

The above embodiments are described merely for a schematic purpose, wherein the units explained as individual members may or may not be physically separated, the members shown as units may or may not be physical units and they can be placed at a position or also can be distributed to network units. As necessary in practice, some or all of the modules can be selected to complete the objectives of the schemes of the embodiments. An ordinary person skilled in the art may understand and implement the embodiments without contributing creative labor.

Through above description of the implementations, it is obvious for the skilled in the art that the implementations can be completed by means of software in connection with necessary universal hardware platform or of course by means of hardware. Based on this understanding, the essence of aforesaid technical schemes or the part contributing to the prior art can be embodied in a form of software product. The computer software product can be stored in computer readable storage medium, such as ROM/RAM, magnetic disc, compact disc and the like, which contains a plurality of instructions such that a computing device (such as, personal computer, server or network apparatus) is able to execute the methods as described in the embodiments or a portion of the embodiment.

In the end, it should be explained that aforesaid embodiments are provided for the purpose of illustrating not limiting the technical schemes of the disclosure. Although the present disclosure has been described in detail with reference to the embodiments, it should be understood that modifications or equivalent substitutions can be made to the technical schemes or some of technical features therein as disclosed in the embodiments by those skilled in the art; the modifications or substitutions will not bring the essence of the respective technical schemes to depart from spirit and scope of the technical schemes of the inventive embodiments.

1. A vehicle control method, comprising:
monitoring whether a warning apparatus of a vehicle is triggered to raise alarm after determining the vehicle is locked; and
switching on a camera apparatus in the vehicle to capture multimedia data about surroundings of the vehicle when the warning apparatus is triggered to raise alarm.

2. The method according to claim 1, further comprising:
acquiring predefined terminal information; and
sending the multimedia data to a terminal apparatus corresponding to the terminal information.

3. The method according to claim 1, further comprising:
storing the multimedia data.

4. The method according to claim 3, further comprising:
sending a prompt message after determining the vehicle is unlocked, wherein the prompt message is used for reminding a vehicle owner to timely review the stored multimedia data.

5. The method according to claim 1, wherein after the step of switching on the camera apparatus in the vehicle, the method further comprises:
determining whether a defined time is reached, and switching off the camera apparatus when determining the defined time is reached.

6. The method according to claim 1, wherein the step of switching on the camera apparatus in the vehicle to capture multimedia data about surroundings of the vehicle comprises:
switching on the camera apparatus in the vehicle to take photos or record videos on the surroundings of the vehicle, the photos and/or videos being multimedia data.

7. A vehicle control device, comprising:
at least one processor; and
a memory for storing at least one instruction executable by the at least one processor,
wherein the at least one processor is configured to:
monitor whether a warning apparatus of a vehicle is triggered to raise alarm after determining the vehicle is locked; and
switch on a camera apparatus in the vehicle to capture multimedia data about surroundings of the vehicle when the warning apparatus is triggered to raise alarm.

8. The device according to claim 7, wherein the at least one processor is further configured to:
acquire predefined terminal information; and
send the multimedia data to a terminal apparatus corresponding to the terminal information.

9. The device according to claim 7, wherein the at least one processor is further configured to:
store the multimedia data.

10. The device according to claim 9, wherein the at least one processor is further configured to:
send a prompt message after determining the vehicle is unlocked, wherein the prompt message is used for reminding a vehicle owner to timely review the stored multimedia data.

11. The device according to claim 7, wherein the at least one processor is further configured to:
determine whether a defined time is reached after the switching-on module switches on the camera apparatus of the vehicle, and switch off the camera apparatus when determining the defined time is reached.

12. The device according to claim 7, wherein the at least one processor is further configured to:
switch on the camera apparatus of the vehicle to take photos or record videos on the surroundings of the vehicle, the photos or videos are multimedia data.

13. The device according to claim 7, wherein the at least one processor is further configured to:
switch on the camera apparatus of the vehicle to take photos and record videos on the surroundings of the vehicle, the photos and videos are multimedia data.

14. The method according to claim 1, wherein the step of switching on the camera apparatus in the vehicle to capture multimedia data about surroundings of the vehicle comprises:
switching on the camera apparatus in the vehicle to take photos and record videos on the surroundings of the vehicle, the photos and videos being multimedia data.
